(19) United States
(12) Patent Application Publication
(10) Pub. No.: US 2009/0186690 A1
(43) Pub. Date: Jul. 23, 2009

(54) SYSTEM AND METHOD OF PROVIDING REWARDS FOR CASINO GAMING

(76) Inventors: George Toth, Sea Isle City, NJ (US); Sharon Kopin, Camarillo, CA (US)

Correspondence Address: GREER, BURNS & CRAIN, 300 S WACKER DR, 25TH FLOOR, CHICAGO, IL, 60606, US

(21) Appl. No.: 12/017,502

(22) Filed: Jan. 22, 2008

(51) Int. Cl. A63F 9/24; G07F 17/32; G06F 19/00

(52) U.S. Cl. 463/25; 463/42; 235/380

(57) ABSTRACT

A method of providing rewards for casino gaming includes a system receiving a request and creating a player record in a database by obtaining player data including a balance, and assigning the player record a unique key. A casino bank communicates with the database and creates a player debit account. The database updates the player record to include a unique debit account identifier linked to the debit account. The database copies the key to the redemption card and the database copies the debit account identifier to the redemption card, if the debit account identifier is not already encoded on the redemption card, and authorizes a terminal to dispense the redemption card. The database updates the balance of the player record upon the player gambling, wherein the redemption card is provided to the terminal which receives and communicates the key and transaction data to the database for updating the player record.

### BACKGROUND OF THE INVENTION

The present invention relates generally to casino gaming, and more specifically, to a system and method for providing rewards for a point-based loyalty casino gaming system.

Casinos are known for providing players with a centralized location in which they can play any one of a number of games involving chance, typically referred to as casino gambling. A typical game of chance requires a player to place a bet (typically money) with the casino hoping that through luck, skill, or a combination of the two, the player will win the game and take away more money than the wagered amount. However, the casino games are typically designed such that the casino, also known as the “house,” has a better chance of winning. Statistically, this allows casinos to turn a profit provided a sufficient number of games are being played. As such, the casino's profit increases proportionally with an increase in the number of games played. Thus, one design criteria of a casino rewards system is to increase the number of games being played by players at the casino.

While some of the first casinos required players to wager actual cash, casinos have evolved to provide better security and organization by allowing players to “purchase” items that represent cash. Common types of these cash substitutes are plastic chips, frequently referred to as “poker chips.” The player gambles with these poker chips as if they were cash and eventually can “cash-out” by returning the chips to the casino for money.

Recent advances in technology have allowed casinos to implement electronic-based systems for casino gambling. In recent implementations, players are given a storage device (e.g., a card with a magnetic strip) that is linked to a corresponding player account. The player then pays money to load the card with points to be used in the casino. Upon playing a game, a certain number of points (based on the size of the bet) is electronically deducted from the player's account by, for example, swiping the card through a card-reader connected to a database accessing the player's account. Similarly, if the player wins the game, points are added to the account. Such systems then allow players to login to terminals within the casino and “spend” (i.e., redeem) their points, by selecting merchandise which is optionally shipped to their hotel rooms or homes. Such systems are well-liked by players as they provide a fast and simple method for redeeming points. Thus, another design criteria of a casino rewards system is the speed and ease of which a player can convert his points into something of value to him.

### BRIEF SUMMARY OF THE INVENTION

The above-listed needs are met or exceeded by the present system and method of providing rewards for casino gaming, which features an electronic data card such as a conventional credit/debit card hereafter referred to as a redemption card that can be requested by a player gambling at a casino implementing a traditional point-based system. Such players are not limited to spending their points on merchandise as these redemption cards are linked to their point account providing several options for spending their points. Specifically, these redemption cards are linked to a bank account such that players can use them as debit or prepaid credit cards with merchants or the like. Players can also use these redemption cards as automatic teller machine (ATM) cards to withdraw cash. Finally, players have the option of transferring funds directly into to a bank account of their choice. These redemption cards allow the players to use their points like cash or even literally convert their points to cash. These redemption cards also double as a traditional gambling cash substitute (similar to the poker chips and electronic card discussed in the background). Therefore, only a single device is needed to both gamble in the casino and redeem any available points in the player's account. The speed and ease with which such redemption cards can be used results in a more attractive casino gambling system to potential and existing players, thus resulting in more games being played, which is beneficial to the casino.

More specifically, a method for providing rewards for casino gaming is provided, which includes the steps of creating a player record in a player database by obtaining player data including a player balance and assigning the player record a player key, a casino bank creating a player debit account with an account identifier using the player data, the player database copying the player key and the player debit account identifier to a storage medium, if the player debit account number is not already encoded on the storage medium, and authorizing a terminal to dispense the storage medium, and the player database updating the player balance upon the player gambling.

A second embodiment provides a method for providing rewards for casino gaming, which includes the steps of creating a player record in a player database by obtaining player data including a player balance and assigning the player record a player key, the player database copying the player key to a temporary storage medium and authorizing a terminal to dispense the temporary storage medium, the player database updating the player balance upon the player gambling, the casino terminal receiving a request to create a redemption card, a casino bank creating a player debit account and the player database updating the player record to include a player debit account identifier, a redemption card production center communicating with the player database and creating the redemption card having the player key and the player debit account identifier, the redemption card being able to function as the temporary data storage medium.

In a third embodiment, a system for providing rewards for casino gaming is configured for receiving a request and creating a player record for a player in a player database by obtaining player data including a player balance, and assigning the player record a unique player key. The system also instructs a casino bank to communicate with the player database and creates a player debit account using the player data. Next, the system instructs the player database to update the player record to include a unique player debit account identifier linked to the player debit account. Following this update, the system instructs the player database to copy the player key and the player debit account identifier to a redemption card and authorizes at least one casino terminal to dispense the redemption card. Finally, the system instructs the player database to update the player balance of the player record upon the player gambling in a casino, wherein the redemption card is provided to the at least one casino terminal which receives and communicates the player key and gambling transaction data to the player database for updating the player record.

### BRIEF DESCRIPTION OF THE SEVERAL VIEWS OF THE DRAWINGS

FIG. 1 is a flow-chart of a system embodying the present method.

FIG. 2 is a flow-chart of a system incorporating an alternate embodiment of the present system.

### DETAILED DESCRIPTION OF THE INVENTION

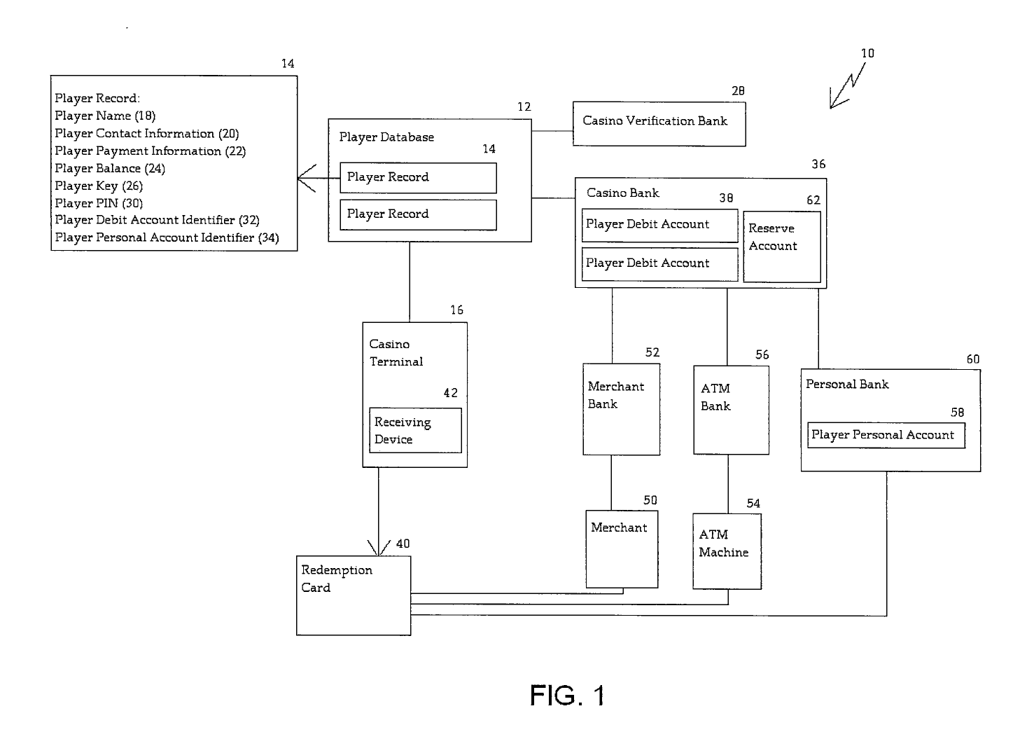

Referring now to FIG. 1, a casino rewards system, generally designated 10 includes a player database 12, which employs at least one player record 14. In the preferred embodiment, a player record 14 is created when a request is made and data is provided, preferably by a player to at least one casino terminal 16 communicating with the player database 12. However, a player record 14 can also be created by the player providing data through the Internet or by the player database 12 communicating with another database or the like. It is noted that the at least one casino terminal 16 is preferably electronic, but may also included a manual station at a casino (e.g., being run by a casino clerk). In the present application, “casino” will be understood to refer to any type of gaming establishment, including but not limited to online or virtual gaming systems, as well as conventional physical casinos or other physical gaming facilities.

The data provided and stored in the player record 14 includes, but is not limited to a player name 18, player contact information 20, player payment information 22 (e.g., bank, credit card, or checking account information), and a player balance 24. The player balance 24 is set to a numeric value upon charging the player a specified amount of money using the player payment information 22. Further, a unique player key 26 is assigned to the player record 14 to identify the player record. It is noted that the type of data stored in the player record 14 may be supplemented, substituted, or modified as needed.

To process a payment from the player, a request for payment verification is sent to a casino verification bank 28. Upon receiving verification, the player balance 24 is established. The player balance 24 identifies how many “points” the player has that can be used in the casino for playing games. It is noted that some forms of payment (e.g., cash) will not require verification and in such instances, the player payment information 22 will be given a value indicating such payment was made and the player balance 24 will be set accordingly. The player record 14 also contains fields for a player PIN 30, a player debit account identifier 32, and a player personal account identifier 34, but since these fields are unused as this stage, they will be described later as they become needed.

A casino bank 36 then communicates with the player database 12 and creates a player debit account 38 using data in the player record 14. The player record 14 is then updated to include the player debit account identifier 32 of the player debit account 38, providing a link between the player record and the player debit account.

To allow the player to use his points in the casino and redeem his point balance 24, a redemption card 40, preferably a card having a magnetic strip, is encoded with a copy of the player key 26 and the player debit account identifier 32 and is issued, preferably to the player from the at least one casino terminal 16. The optional player PIN 30, required to make transactions, may also be added to the player record 14, associated with the redemption card 40, and provided to the player for added security as is commonly used with credit/debit cards. It is noted that such data could be encoded using a variety of known technologies, including, but not limited to the use of bar codes or computer chips. However, since the redemption card 40 is intended to be used, among other things, as a traditional credit card, the redemption card 40 is preferably configured to replicate the design of a traditional credit card (i.e., a standard credit card shape with a magnetic strip).

In addition, since the redemption 40 card is intended to be used as a traditional credit card, it is desired to have traditional credit card features (e.g., an imprinted account number). While it is contemplated that such imprinting of the player debit account identifier 32 or the like be done at the at least one casino terminal 16, it is noted that casinos may stock pre-imprinted redemption cards 40. In such cases, the player debit account identifier 32 is copied from the redemption card 40 to the player record 14, preferably when the other data in the player record 14 is obtained. Further in such cases, the player debit account identifier 32 is communicated to the casino bank 36 when the player debit account 38 is created. Thereafter, when the redemption card 40 is actually dispensed, it is preferred that an activation authorization is communicated, preferably from the at least one casino terminal 16 to the casino bank 36, causing the player debit account 38 to be activated. Such an activation is preferably only used when redemption cards 40 are pre-imprinted with the player debit account identifier 32.

With respect to the data maintained on the redemption card 40, it is noted that all data in the player record 14 could be copied to the redemption card, however as is well-known by a person of ordinary skill in the art, it is preferred to retain as much data as possible in a database and allow such data to be accessed by providing a unique identifier linked to that data (i.e., the player key 26). Such an implementation is well known to provide greater organization and consistency of data. It is also noted that the steps of creating of the player record 14, creating the player debt account 44, and dispensing the redemption card 40 could be performed in a different order, so long as the data is properly maintained.

As the player gambles in the casino, the redemption card 40 is provided to the at least one casino terminal 16 or otherwise is used to communicate with the player database 12 to update the player balance 24 in the player record 14. For example, if a player uses a slot machine, the redemption card 40 is swiped through the slot machine, and the points necessary for a single use would be deducted from the player balance 24. Similarly, if the player won the slot machine game, a defined number of points would be added to the player balance 24.

Any method of communication between the redemption card 40 and the player database 12 is contemplated that is capable of maintaining an updated player balance 24. However, it is preferred that the player swipes the redemption card 40 through a receiving device 42 in the at least one casino terminal 16 each time a game is played, which in turn, communicates the player key 26 and any necessary transaction data (i.e., the wagered amount) to the player database 12 for updating the player record 14.

The player can use the redemption card 40 to redeem points by taking advantage of the link between the redemption card 40 and the player debit account 38. In particular, the player can use the redemption card 40 as a traditional debit/credit card, as a traditional ATM card to obtain cash, or to transfer funds into a personal account. The player can use the redemption card 40 as a credit/debit card by presenting it to a merchant 50 as payment for goods or services, preferably along with the player PIN 30 for verification. Thereafter, a merchant bank 52 communicates with the casino bank 36 such that funds are appropriately transferred as with a traditional credit/debit card transaction.

Similarly, the redemption card 40 can be used as an ATM card by presenting the redemption card to an ATM machine 54 to withdraw a specified amount of cash, preferably along with the player PIN 30 for verification. Thereafter, an ATM bank 56 communicates with the casino bank 36 such that funds are appropriately transferred and cash is dispensed from the ATM machine 54 as with a traditional ATM withdrawal transaction.

Finally, funds can be transferred from the player debit account 38 to a designated player personal account 58 at a personal bank 60 upon a request, preferably made by the player at the at least one casino terminal 16 and preferably along with the player PIN 30 for verification. It is noted that transferring funds from the player debit account 38 to a player personal account 58 can also be initiated at a bank, online, or at any other place that provides such services, hereafter referred to as a transfer terminal. The associated player personal account identifier 34 is then added to the player record 14 such that similar transfers to the player personal account 58 can be quickly and easily performed in the future.

Regardless of how the redemption card 40 is used to redeem points, it is preferred that a determination is made whether sufficient funds are available in the player debit account 38 as a precondition to carrying out a related transaction. However, it is noted that a reserve account 62 is optionally used to facilitate transactions in the event that the player debit account 38 does not have sufficient funds to complete a requested transaction. In such cases, funds from the reserve account 62 are used by the casino to cover the deficiency, but are expected to be repaid by the player. The amount and frequency of these inadequately funded transactions are among the factors to be considered in the discretionary use of the reserve account 62 by the casino.

As the redemption card 40 is used to redeem points, it is important to maintain consistency between the player balance 24 (i.e., the “points” in the player record 14 for gambling) and the funds available in the player debit account 38 (the “points” available in the casino bank 36 for spending like cash). However, since transactions involving the casino bank 36 do not modify the player balance 24 in the player record 14, a communication between the player database 12 and the casino bank 36 is periodically made to ensure consistency between both fields. Preferably, at least daily scheduled inquiries are made by the player database 12 to the casino bank 36 such that the player balance 24 in the player record 14 is properly updated. Further, to provide accounting benefits and minimize financial risk, the redemption card 40 and the corresponding player debit account 38 can be assigned expiration dates, as needed, preferably twenty-four months. Thereafter, the casino bank will reject any transaction concerning the player debit account 38 and the player will forfeit any unclaimed points remaining in the player balance 24.

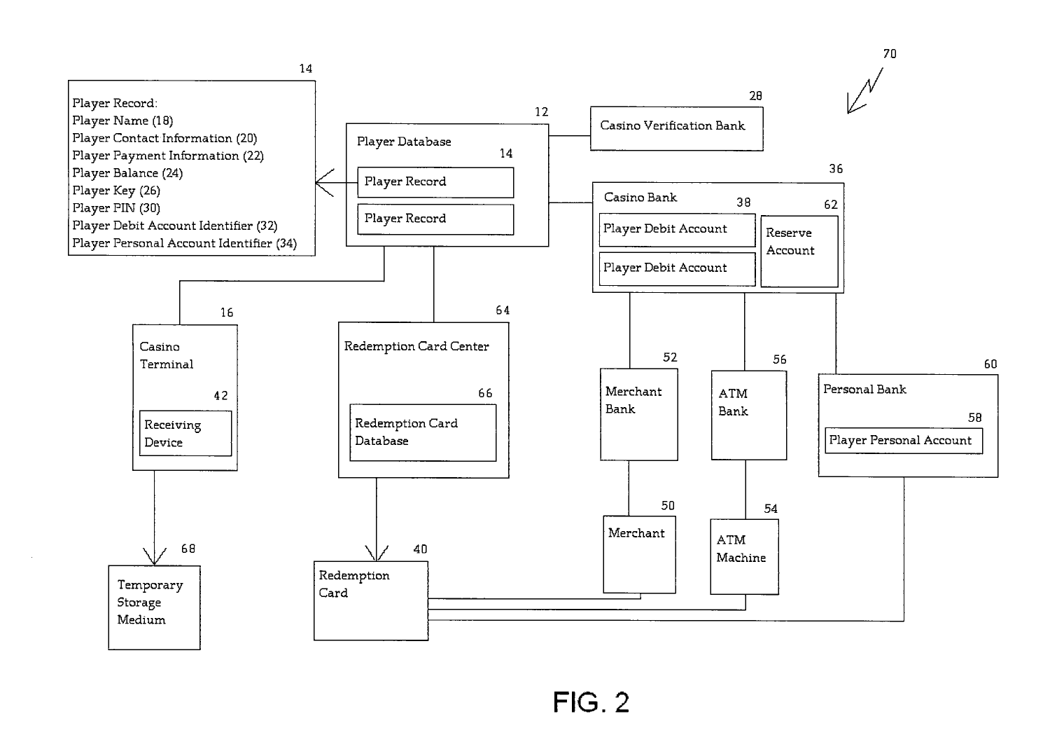

In a second embodiment as shown in FIG. 2, an alternate casino rewards system 70 is shown, in which components shared with the casino rewards system 10 are designated with identical reference numbers. The main difference between the two systems 10, 70 is that in the alternate system 70, a player is provided with a temporary storage medium to use for gambling while the redemption card 40 is created and send to the player. As shown in FIG. 2, the redemption cards 40 are produced using a redemption card production center 64 having a redemption card database 66 that communicates with the player database 12, receiving daily batches of card requests. Copies of the player key 26 and the player debit account identifier 32 are encoded on the redemption card 40, preferably as a magnetic strip.

Redemption cards 40 are then delivered to the corresponding player, preferably by mail, according to the player contact information 20 stored in the player record 14. Preferably, the player will receive the redemption card 40 within one to two days after the request is made. To allow players to gamble and accumulate points during this interim, a temporary storage medium 68, encoded (as with the redemption card) with the player key 26, is dispensed, preferably from the at least one casino terminal 16 to the player. Since the temporary storage medium 68 is encoded with the same player key 26 that will be later encoded in the redemption card 40, the latter can replace the former for gambling and the like within the casino.

It is also noted that many players will have existing point-based accounts, as discussed in the background, that were created prior to the implementation of a system using the redemption cards 40. Therefore, it is noted that in such circumstances, some or all of the data in the player record 14 will be obtained by communicating with a legacy database or the like instead of being provided as new data as discussed in the preferred embodiment. In such circumstances, a redemption card 40 will replace an existing card or the like as used by the player.

With respect to all embodiments, it is noted that any transaction preferably made at the at least one casino terminal 16, can each be made at a different casino terminal. For example, the player can create a player record 14 at one casino terminal at one casino, request a redemption card at a second casino terminal in a second casino, and gamble with the redemption card at a third casino terminal in a third casino. Further, while the method and system as described, has a specified order of steps, it is noted that the steps could be performed in any of a number of permutations while still achieving the same or similar result.

In addition, it is preferred that the casino rewards programs 10, 70 are implemented using a computer software program or other known implementation techniques that allow for instructing or signaling (considered equivalent operations) entities to perform tasks or operations. The software program establishes electronic versions of the player database 12, the player record 14, the casino terminal 16, the player debit account 38, the player personal account 58, the reserve account 62; and the redemption card database 66, provides for electronic communication between all the entities (banks, merchants, player, etc.); the electronic production of the temporary storage mediums 36 and the redemption card 40; and any other step, task, or operation, including all those provided in FIG. 1 and FIG. 2, or which otherwise could be carried out using computer software or the like.

While a particular embodiment of the present system and method of providing rewards for casino gaming has been described herein, it will be appreciated by those skilled in the art that changes and modifications may be made thereto without departing from the invention in its broader aspects and as set forth in the following claims.

We claim:

1. A method of providing rewards for casino gaming, comprising:
a casino rewards system receiving a request and creating a player record for a player in a player database by obtaining player data including a player balance, and assigning said player record a unique player key;
a casino bank communicating with said player database and creating a player debit account using said player data;
said player database updating said player record to include a unique player debit account identifier linked to said player debit account;
said player database copying said player key to a redemption card;
said player database copying said player debit account identifier to said redemption card, if said player debit account identifier is not already encoded on said redemption card, and authorizing at least one casino terminal to dispense said redemption card; and
said player database updating said player balance of said player record upon said player gambling in a casino, wherein said redemption card is provided to said at least one casino terminal which receives and communicates said player key and gambling transaction data to said player database for updating said player record.

2. The method of claim 1 further comprising:
said player database periodically communicating with said casino bank such that said player balance can be updated to reflect a balance in said player debit account.

3. The method of claim 1 further comprising:
said redemption card, if presented as payment to a merchant, being used as a credit or debit card as by reading and communicating said player debit account identifier to a merchant bank causing a transfer of funds from said player debit account at said casino bank to a merchant account at said merchant bank.

4. The method of claim 3 further comprising:
said casino rewards system ensuring sufficient funds are available in said player debit account before transferring said funds from said player debit account to said merchant account.

5. The method of claim 3 further comprising:
said casino bank creating a reserve account providing funds when a transaction is made requiring funds to be transferred out of said player debit account when said player debit account has insufficient funds.

6. The method of claim 1 further comprising:
said player database associating said player debit account with a player PIN by adding said player PIN to said player record;
said player PIN being provided to said player,
said player using said redemption card at an automatic teller machine, wherein said player provides said player PIN and said automatic teller machine communicates said player debit account identifier to an ATM bank; and
said funds are transferred from said casino bank to said ATM bank and said ATM machine dispenses cash.

7. The method of claim 1 further comprising:
a player personal bank creating a player personal account having a player personal account identifier;
said player database adding said player personal account identifier to said player record;
a transfer terminal receiving a request to transfer funds from said player debit account to said player personal account; and
said transfer terminal communicating with said casino bank and said player personal bank and transferring funds from said player debit account to said player personal account.

8. The method of claim 1 wherein said player debit account expires after some time period.

9. The method of claim 8 where said time period is twenty-four months.

10. The method of claim 1 wherein said player data further includes a player name, player contact information, and player payment information.

11. The method of claim 1 wherein said redemption card is associated with a predetermined player debit account identifier before said request for creating a player record is made.

12. The method of claim 11 wherein said at least one casino terminal communicates an authorization to said casino bank to activate said redemption card.

13. A method of providing rewards for casino gaming, comprising:
a casino rewards system receiving a request and creating a player record for a player in a player database by obtaining player data including a player balance and assigning said player record a unique player key;
said player database copying said player key to a temporary data storage medium and authorizing at least one casino terminal to dispense said temporary data storage medium;
said player database updating said player balance of said player record upon said player gambling in a casino, wherein said temporary data storage medium is provided to said at least one casino terminal which receives and communicates said player key and gambling transaction data to said player database for updating said player record;
said at least one casino terminal receiving a request to create a redemption card;
a casino bank creating a player debit account and said player database updating said player record to include a unique player debit account identifier linked to said player debit account; and
a redemption card production center communicating with said player database and creating said redemption card having said player key and said player debit account identifier, said redemption card being able to function as said temporary data storage medium.

14. The method of claim 13 further comprising said player database copying said player record to a redemption card database in said redemption card production center as part of a batch file of requests for said redemption cards, wherein said redemption card is created using said redemption card database and said redemption card is sent from said redemption card production center to said player.

15. A system for providing rewards for casino gaming, wherein said system:
receives a request and creates a player record for a player in a player database by obtaining player data including a player balance, and assigning said player record a unique player key;
instructs a casino bank to communicate with said player database and create a player debit account using said player data;
instructs said player database to update said player record to include a unique player debit account identifier linked to said player debit account;
instructs said player database to copy said player key and said player debit account identifier to a redemption card and authorizes at least one casino terminal to dispense said redemption card; and
instructs said player database to update said player balance of said player record upon said player gambling in a casino, wherein said redemption card is provided to said at least one casino terminal which receives and communicates said player key and gambling transaction data to said player database for updating said player record.

16. The system of claim 15 wherein the system is a computer software program.
